(19) United States
(12) Patent Application Publication
(10) Pub. No.: US 2008/0077370 A1
(43) Pub. Date: Mar. 27, 2008

(54) System and method for integrating a process control system into a training simulator

(75) Inventor: Alexander Frick, Schriesheim (DE)

Correspondence Address: BUCHANAN, INGERSOLL & ROONEY PC, POST OFFICE BOX 1404, ALEXANDRIA, VA, 22313-1404, US

(73) Assignee: ABB Technology AG, Zurich (CH)

(21) Appl. No.: 11/905,040

(22) Filed: Sep. 27, 2007

(30) Foreign Application Priority Data
Sep. 27, 2006 (DE) 10 2006 045 503.7

(51) Int. Cl. G06G 7/66

(52) U.S. Cl. 703/6

(57) ABSTRACT

The disclosure relates to a system and method for integrating a process control system for a technical installation or a technical process into a training simulator, where the training simulator interacts with a virtual PC. The virtual PC stores a piece of software for modelling the technical installation or the technical process and stores a piece of software for modelling the user interface of the process control system. In addition, the virtual PC holds a further piece of software for executing functionalities for the simulation. The virtual PC interacts with the training simulator such that the functionalities for the simulation can be actuated using the training simulator.

### RELATED APPLICATIONS

This application claims priority under 35 U.S.C. §119 to German Application 10 2006 045 503.7 filed in Germany on Sep. 27, 2006, the entire contents of which are hereby incorporated by reference in their entireties.

### TECHNICAL FIELD

A system and method for integrating a process control system for a technical installation or a technical process into a training simulator is disclosed and is provided particularly for use in the oil and gas industry, the chemical industry or energy production.

### BACKGROUND INFORMATION

Training simulation systems are used for training installation operators in order to model the operation of a technical installation or a technical process without impairing or endangering production in the process.

Simulating a technical process requires modelling of the process, which usually involves original replication of the observation and operator station, also called user interface, and the appropriately lodged logic functions.

Important requirements during the simulation of the technical process cannot be provided by the user interface and hence also by its original replication, however.

At present, the existing software for a process control system's user interface is therefore extended by additional functionalities which are provided for the simulation of a technical process. By way of example, the additional functionalities are starting or stopping the technical process, buffer-storage of instantaneous values or simulation settings, or a piece of software for modelling the relevant logic functions which are required during the simulation of the technical process.

Accordingly, the installation's control units, subsequently also referred to as controllers, are also modelled, and the models of the controllers likewise lack the functionalities needed for a training simulation. It is therefore necessary not only to alter the user interface's existing software but also to extend the software of the controllers by additional functionalities.

Another practice for simulating the technical process involves complete modelling of the automation system and of the observation and operator station within a process simulator, but this is associated with time-consuming and cost-intensive programming of the process simulator.

### SUMMARY

Accordingly, an object of the disclosure is to specify a system and method for integrating a process control system for a technical installation or a technical process into a training simulator which overcome the aforementioned drawbacks of the prior art.

In line with the disclosure, the system for integrating a process control system for a technical installation or a technical process into a training simulator comprises a virtual personal computer (PC).

The virtual PC is a model of a data processing device and is integrated as a separate software program in a window of a software platform, the software platform being able to be independent of existing operator stations for the technical installation or the technical process.

The virtual PC stores a piece of software for modelling the technical installation or the technical process as an emulation of the process control system and also stores a piece of software for modelling the user interface of the process control system.

In addition, the virtual PC provides a further piece of software for executing functionalities for the simulation. Hence, the virtual PC is able to interact with the training simulator in order to actuate the functionalities for the simulation using the training simulator and to execute the simulation of the technical process or the technical installation using the software stored on the virtual PC.

In one advantageous embodiment of the inventive system, provision is made for the virtual PC to be used to store a piece of software for modelling controllers for the technical installation or the technical process which is likewise able to be used for the simulation of the technical process or the technical installation.

By way of example, the functionalities provided for the simulation by the virtual PC can be actuated using an interface such that a virtual network, also referred to as virtual server, can advantageously be started and stopped as desired and instantaneous values or simulation settings and/or simulation results can be buffer-stored. The virtual network, comprising user interfaces, what is known as the server and clients, and the models of the process control system, is therefore a map of the complete network configuration which is virtually mapped within a control system project directly.

In another embodiment of the inventive system, the virtual PC is connected by means of an interface to a trainer station, also referred to as instructor, so that an instruction for executing the respectively required functionality can be supplied to the virtual PC by the instructor via the interface.

The advantages of the disclosure also involve the use of the virtual PC to model the technical process or the technical installation and the relevant functions for the simulation without extending the original software of the user interface for the process control system by additional functionalities required for the simulation in order to do so.

In addition, all original files and tools which are used for the user interface and the controllers can be used without time-consuming customization.

In one refinement of the inventive system, the complete network configuration can be mapped within a control system project using the virtual PC directly and can be used by the training simulator.

Besides for simulating the operation of the technical installation or the technical process, the inventive system is advantageously also provided for developing, testing and/or validating a control system configuration and also for checking the installation design prior to start-up of the technical installation and/or for testing safety-critical installation components.

An exemplary method for integrating a process control system for a technical installation or a technical process into a training simulator involves the training simulator being connected to a virtual PC. The virtual PC is used to store a piece of software for modelling the technical installation or the technical process and to store a piece of software for modelling the user interface of the process control system. In addition, the virtual PC is used to store a further piece of software for executing functionalities for the simulation, with the functionalities for the simulation which are stored in the virtual PC being actuated using the training simulator.

Hence, a virtual PC is advantageously used to model the technical process or the technical installation and the relevant functions for the simulation without extending the software of the user interface for the process control system and the software for the controllers by additional functionalities required for the simulation in order to do so.

### BRIEF DESCRIPTION OF THE DRAWINGS

The exemplary embodiment shown in the FIGURE below is intended to explain and describe the disclosure and also further advantageous refinements, improvements and further advantages of the invention in more detail.

FIG. 1 shows an embodiment of the inventive system for integrating a process control system in a training simulator 30 for a technical installation and comprises a training simulator 30 which interacts with a virtual PC 20.

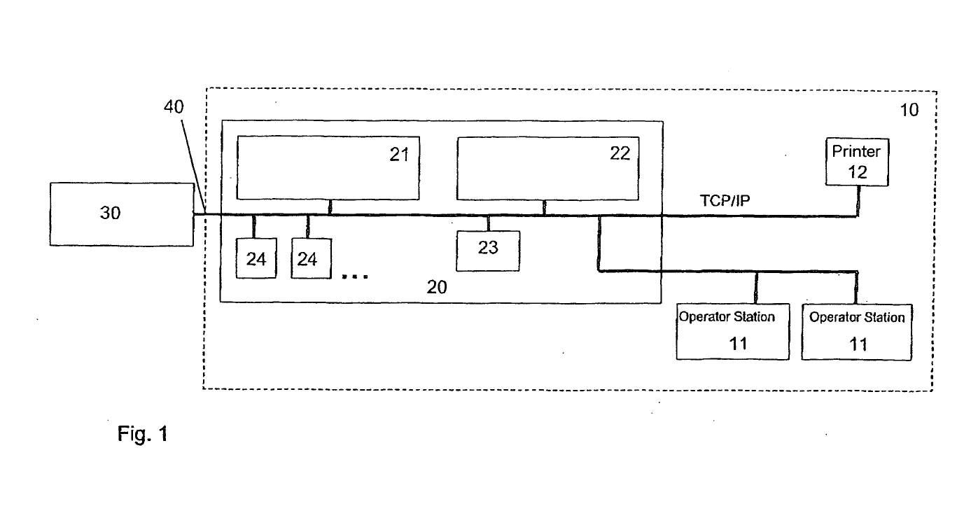

### DETAILED DESCRIPTION

The virtual PC 20 is integrated as a separate software program in a window of a software platform 10, for example a man-machine interface, for the process control system, which software platform also comprises operator stations 11 and actuators for external hardware devices, such as printers.

For the purpose of modelling the technical installation for the simulation, the virtual PC 20 stores a piece of software for modelling the user interface of the process control system 21 and stores a further piece of software for executing functionalities for the simulation 22.

The virtual PC 20 interacts with the training simulator 30 such that the functionalities for the simulation can be actuated via an interface 40 using the training simulator 30. For the communication between the virtual PC 20 and the training simulator 30, the TCP/IP protocol is preferably used.

The virtual PC 20 also stores a model of the controllers 23 for the technical installation and the relevant functionalities which are required for the training simulation. The relevant functionalities for the training simulation can likewise be actuated using the training simulator 30.

Advantageously, the functions which are required by the simulation are started and/or stopped via an Internet connection.

What is claimed is:

1. System for integrating a process control system for a technical installation or a technical process into a training simulator, where
the training simulator interacts with a virtual PC,
the virtual PC stores a piece of software for modelling the technical installation or the technical process and a piece of software for modelling the user interface of the process control system,
the virtual PC holds a further piece of software for executing functionalities for the simulation, and
the virtual PC interacts with the training simulator such that the functionalities for the simulation can be actuated using the training simulator.

2. System according to claim 1, wherein the virtual PC (20) is a model of a data processing device and can be executed as a separate software program in a window of a software platform (10).

3. System according to claim 1, wherein the functionalities provided for the simulation by the virtual PC can be actuated using an interface.

4. System according to claim 3, wherein the further software for executing functionalities for the simulation can be transferred from an instructor via the interface to the virtual PC.

5. System according to claim 1, wherein the virtual PC stores a piece of software for modelling controllers for the technical installation or the technical process and stores the relevant functionalities for the simulation.

6. System according to claim 1, wherein the complete network configuration can be mapped within a control system project using the virtual PC directly and can be used by the training simulator.

7. System according to claim 1, wherein besides the simulation of the operation of the technical installation or of the technical process there is also provision for development, testing and/or validation of a control system configuration and/or checking of the installation design prior to start-up and/or testing of safety-critical installation components of the technical installation.

8. Method for integrating a process control system for a technical installation or a technical process into a training simulator, where
the training simulator is connected to a virtual PC,
the virtual PC is used to store a piece of software for modelling the technical installation or the technical process and a piece of software for modelling the user interface of the process control system,
the virtual PC is also used to store a further piece of software for executing functionalities for the simulation, and
the functionalities for the simulation which are stored in the virtual PC are actuated using the training simulator.

9. Method according to claim 8, wherein the virtual PC is executed as a separate software program in a window of a software platform.

10. Method according to claim 8, wherein the functionalities provided for the simulation by the virtual PC are actuated using an interface.

11. Method according to claim 10, wherein the further software for executing functionalities for the simulation is transferred from an instructor via the interface to the virtual PC.

12. Method according to claim 8, wherein the virtual PC is used to store a piece of software for modelling controllers for the technical installation or for the technical process and to store the relevant functionalities for the simulation.

13. Method according to claim 8, wherein the complete network configuration is mapped within a control system project using the virtual PC directly and is used by the training simulator.

14. Method according claim 8, wherein besides the simulation of the operation of the technical installation or the technical process there is also the performance of development, testing and/or validation of a control system configuration and/or checking of the installation design prior to start-up and/or testing of safety-critical installation components of the technical installation.

15. System according to claim 2, wherein the functionalities provided for the simulation by the virtual PC can be actuated using an interface.

16. System according to claim 4, wherein the virtual PC stores a piece of software for modelling controllers for the technical installation or the technical process and stores the relevant functionalities for the simulation.

17. System according to claim 5, wherein the complete network configuration can be mapped within a control system project using the virtual PC directly and can be used by the training simulator.

18. System according to claim 6, wherein besides the simulation of the operation of the technical installation or of the technical process there is also provision for development, testing and/or validation of a control system configuration and/or checking of the installation design prior to start-up and/or testing of safety-critical installation components of the technical installation.

19. Method according to claim 9, wherein the functionalities provided for the simulation by the virtual PC are actuated using an interface.

20. Method according to claim 11, wherein the virtual PC is used to store a piece of software for modelling controllers for the technical installation or for the technical process and to store the relevant functionalities for the simulation.

21. A method for integrating a process control system, comprising:
storing in a virtual PC a piece of software for modelling a technical installation or a technical process, and a piece of software for modelling a user interface of the process control system;
storing in the virtual PC a further piece of software for executing functionalities for a simulation; and
actuating the functionalities for the simulation which are stored in the virtual PC using a training simulator.
